(19) United States
(12) Patent Application Publication
(10) Pub. No.: US 2024/0090525 A1
(43) Pub. Date: Mar. 21, 2024

(54) COFFEE-TEA BASED BEVERAGE MIXTURE

(71) Applicant: Donald N. Frantum, JR., Las Vegas, NV (US)

(72) Inventor: Donald N. Frantum, JR., Las Vegas, NV (US)

(21) Appl. No.: 17/947,364

(22) Filed: Sep. 19, 2022

(51) Int. Cl. A23F 5/14; A23F 3/14

(52) U.S. Cl. CPC A23F 5/14; A23F 3/14; A23V 2002/00

(57) ABSTRACT

The disclosure provides a coffee-tea based beverage mixture suitable for caffeine-sensitive consumers to inhibit jitteriness caused by the caffeine, as well as the methods for making the coffee-tea based beverage mixture. The coffee-tea based beverage mixture is a range of ninety to ninety-six-point-five (90%-96.5%) percent water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. In an embodiment, the mixture is brewed at between 2.7° C. to 105° C. from a range of three to four (3-4) minutes to forty-eight (48) hours of time and, as a cold brew, agitated at every eighteen to twenty-four (18-24) hours. The resulting brewed beverage may include a sweetener or a creamer of type and quantity of choice of the user.

### TECHNICAL FIELD

The disclosure relates to the coffee-tea based beverage mixture, and more particularly, to the coffee-tea based beverage mixture suitable for caffeine-sensitive individuals to inhibit jitteriness caused by the caffeine, as well as the methods for making the coffee-tea based beverage mixture.

### BACKGROUND

Coffee and tea are beloved beverages known for their ability to increase energy, improve focus and boost energy levels. In fact, many people around the world start and fuel their day with coffee and tea. Additionally, coffee and tea are often included in many weight-loss programs as a protocol to improve metabolism, increase energy and stamina, and curb hunger.

In addition to caffeine, coffee and tea organically contain nutrients such as niacin, potassium, magnesium, amino acids, and antioxidants which can improve digestive health, cognitive acuity, support muscle function, and vascular health which can lead to better heart health.

However, many people cannot enjoy the benefits of coffee or tea due to some degree of caffeine sensitivity. While one person might have low sensitivity and be able to drink 250 mg of caffeine without getting any of the negative side effects, a caffeine-sensitive person might have a range of jitteriness in the form of agitation, nervousness, anxiety, insomnia, heart palpitations, headaches, and sweating from far less caffeine.

Therefore, there is a need for a coffee-tea based beverage mixture, that, without removal or reduction of caffeine from the beverage, may suppress all the negative effects and jitteriness caused by caffeine for caffeine-sensitive people while also imparting all of the inherent health and nootropic benefits.

The present disclosure generally relates to the coffee-tea based beverage mixture, and more particularly, to the coffee-tea based beverage mixture suitable for caffeine-sensitive individuals to inhibit jitteriness caused by the caffeine, as well as the methods for making the coffee-tea based beverage mixture.

According to one aspect of the present disclosure, the coffee-tea based beverage mixture comprises a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. In one embodiment, the mixture is brewed in a vessel at between two-point-seven to four-point-four (2.7° C.-4.4° C.) Celsius for thirty-six to forty-eight (36-48) hours of time. In an embodiment, the mixture is agitated every eighteen to twenty-four (18-24) hours.

According to another aspect, coffee-based beverage mixture a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture, and a sweetener and a creamer according to the requirement or taste of the user. The mixture is brewed at between two-point-seven to four-point-four (2.7° C.-4.4° C.) Celsius for thirty-six to forty-eight (36-48) hours of time and agitated every eighteen to twenty-four (18-24) hours.

In one embodiment, the coffee is roasted or non-roasted coffee selected from Arabica or Robusta coffee. The coffee can be flavored or unflavored. In an embodiment, the tea is also any of white, black, or green tea varieties which can be flavored or unflavored that may be according to the taste of a user. In an embodiment, the coffee and tea are blended in a range of ratios of six to one (6:1) to twenty-two to one-point-twenty-five (22:1.25) depending on the brew method in order to prepare the coffee-based beverage mixture.

In another embodiment, the coffee-based beverage mixture a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. The ground tea and ground coffee are brewed together using any of a cold, hot, drip, pour-over. French Press, Moka Pot, or espresso brewing method, where the ratio of coffee to tea is blended in a range of ratios of six to one (6:1) to twenty-two to one-point-twenty-five (22:1.25) in all the methods.

In one aspect of the present disclosure, the method of preparing a coffee-based beverage mixture comprises steps of, providing a range of ninety (90%) to ninety-six point eighty-five (96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture; keeping the mixture at between two-point-seven to four-point-four (2.7° C.-4.4° C.) Celsius for thirty-six to forty-eight (36-48) hours of time, and agitating the mixture at every eighteen to twenty-four (18-24) hours.

The objective of the present disclosure is to provide a coffee-tea based beverage mixture that delivers the benefits of coffee and tea including energy, focus, clarity, alertness, stamina, curbing of hunger, and increased metabolism while also eliminating the negative side effects of caffeine sensitive person might experience, including a range of agitation, nervousness, anxiety, insomnia, heart palpitations, headaches, and sweating, also known as ‘jitters’.

Further, an objective of the present disclosure is to provide a coffee-tea based beverage mixture that comprises non-roasted coffee which is non-roasted thus includes a Chlorogenic acid, a known polyphenol, that research purports offers antioxidant and weight loss benefits.

### DETAILED DESCRIPTION

In the following description, numerous specific details are set forth in order to provide a thorough understanding of the embodiments of the present invention. It will be apparent to one skilled in the art that embodiments of the present invention may be practiced without some of these specific details.

If the specification states a component of the feature “may”, “can”, “could” or “might” be included or have a characteristic, that particular component or feature is not required to be included or have the characteristic.

As used in the description herein and throughout the claims that follow, the meaning of “a”, “an”, and “the” includes plural reference unless the context clearly dictates otherwise. Also, as used in the description herein, the meaning of “in” includes “in” and “on” unless the context clearly dictates otherwise.

The present disclosure relates generally to the coffee-tea based beverage mixture suitable for caffeine-sensitive individuals to inhibit jitteriness caused by the caffeine, as well as the methods for making the coffee-tea based beverage mixture.

According to one aspect, the coffee-tea based beverage mixture comprises a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. The coffee is green (raw) or roasted coffee selected from the variety Arabica (Coffea arabica), Robusta (Coffea canephora), or a combination of the two. The tea (Camellia sinensis) is in white, black, or green varieties. The mixture of coffee and tea is blended in a range of ratios of six to one (6:1) inhibits the jitteriness by the caffeine present within the coffee when mixed and brewed in hot or cold water in order to prepare the coffee-tea based beverage mixture. In another embodiment, the mixture of coffee and tea is blended in a range of ratios of twenty-two to one-point-twenty-five (22:1.25).

In one embodiment, the coffee can be naturally or artificially flavored or unflavored. In one embodiment, the tea can be naturally or artificially flavored or unflavored. In one embodiment of the present disclosure, the resulting brewed coffee-tea based beverage mixture can further include at least one sweetener. The sweetener can be any natural sweeteners, artificial sweeteners, dietary supplements, or sugar alcohols. The sweeteners can be in the form of solid or liquid.

In one embodiment of the present disclosure, the ground tea and ground coffee are brewed together using a hot, drip, pour-over, French Press, Moka Pot, or espresso brewing method, where the ratio of coffee to tea is blended in a range of ratios of six to one (6:1) to twenty-two to one-point-twenty-five (22:1.25) in these methods.

In the embodiment of the present disclosure, the method of preparing a coffee-tea based beverage mixture comprises steps of, providing a range of ninety (90%) to ninety-six point eighty-five (96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture; brewing the mixture at the desired temperature for the specific brew method and device for the entirety of the brew cycle, and agitating the at the interval required by the brew cycle.

According to one aspect of the present disclosure, the coffee-tea based beverage mixture comprises a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. In one embodiment, the mixture is brewed in the vessel at between two-point-seven to four-point-four (2.7° C.-4.4° C.) Celsius for thirty-six to forty-eight (36-48) hours of time. In an embodiment, the mixture is agitated every eighteen to twenty-four (18-24) hours. In one embodiment, the mixture is brewed as an espresso brew which is brewed at between ninety-seven to one hundred four (97° C.-104° C.) Celsius at a pressure of one to fifteen (1-15) bars of pressure for thirty to ninety (30-90) seconds of time. In one another embodiment, the mixture is brewed using the drip brew method at between ninety-seven to one hundred four (97° C.-104° C.) Celsius for five to ten (5-10) minutes of time. In one more embodiment, the mixture is brewed using the French press brew at between ninety-seven to one hundred four (97° C.-104° C.) Celsius for two to six (2-6) minutes of time.

According to one aspect of the present disclosure, the coffee-tea based beverage mixture comprises a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. In one embodiment, the mixture is brewed under 1-9 bars of pressure at between 100° C. to 102° C. per brew cycle.

In the embodiment of the present disclosure, the coffee-tea based beverage mixture comprises a range of ninety to ninety-six-point-eighty-five (90%-96.85%) percent cold water by weight of the mixture, a range of three to eight-point-five (3%-8.5%) percent ground coffee by weight of the mixture and a range of point-fifteen to one-point-fifteen (0.15%-1.15%) percent ground tea by weight of the mixture. In this embodiment, the mixture is brewed using a drip, pour-over, or French press method at between 95° C. to 102° C. per brew cycle.

Further, an objective of the present disclosure is to provide a coffee-tea based beverage mixture that comprises non-roasted coffee which is non-roasted and thus includes a Chlorogenic acid, a known polyphenol, that offers purported antioxidant and weight loss benefits.

In the embodiment of the present disclosure, the resulting brewed coffee-tea based beverage mixture can further include dairy-based or dairy-free creamers. The creamer can be in the form of powder or liquid.

As used herein, the term “water” when used in reference to the beverage mixture means that the beverage mixture includes a total water content of a range of ninety (90%) to ninety-six-point-five (96.5%) percent, in another aspect a range of eighty-five (85%) to ninety-six-point-five (96.5%) percent, in another aspect a range of seventy (70%) to ninety-six-point-five (96.5%) percent by weight, in another aspect a range of fifty (50%) to 96.5 percent by weight, in another aspect a range of forty-five (45%) to ninety-six-point-five (96.5%) percent by weight, and in yet another aspect a range of forty (40%) to ninety-six-point-five (96.5%) percent by weight of the beverage mixture. The total water content includes any sources of water in the concentrate, including for example water present in any liquids, sweetener or liquid creamer, added to the resulting brewed beverage mixture.

The amount of coffee and teas in the beverage may depend, at least in part, on the desired flavor intensity provided to the beverage mixture, however, the coffee and tea are blended in a range of ratios of six to one (6:1) to twenty-two to one-point-twenty-five (22:1.25). The coffee and/or tea solids content in the finished beverage may also depend, at least in part, on whether the beverage may be further diluted, such as by the melting of any ice added to the beverage mixture. For example, higher concentrations of coffee and/or tea solids may be included in lesser quantities and still provide the desired nootropic function and inhibition of caffeine sensitivity. The amount of coffee and/or tea solids in the beverage mixture may also depend on the solubility of the coffee and/or tea solids in the water. For instance, when a lesser quantity of coffee and/or tea solids is desired in the beverage mixture, the beverage mixture may include, for example, approximately three (3%) percent coffee and point fifteen (0.15%) percent tea solids. In other aspects, when a higher amount of coffee and/or tea solids is desired in the water, the final beverage may include, for example, approximately one (1.0) to one-point-seven (1.7%) percent coffee and/or tea solids, in another aspect approximately eight-point-five (8.5%) percent coffee and approximately one-point-five (1.5%) percent tea solids.

By keeping and balancing the optimal amount and/or ratio of the coffee to tea in the coffee-tea based beverage mixture, it was surprisingly found that the amount of caffeine to the naturally occurring amino acid L-Theanine in the beverage mixture was so balanced that it completely removed sense of anxiousness, agitation or jitters even from the caffeine sensitive user. It was surprisingly discovered that, when coffee and tea are mixed in the optimal ratio, caffeine does not adversely affect consumers with caffeine sensitivity.

The amounts of total water, coffee and tea solids, and other additives included in the beverage mixture are balanced to provide the desired flavor profile with little or no degradation of the coffee and/or tea flavors in the coffee and/or tea when brewed for forty-eight (48) hours. In another aspect at least twenty-four (24) hours, in another aspect at least 36 hours, in another aspect at least sixty (60) hours, in another aspect at least seventy-two (72) hours, and in another aspect for five to ten (5-10) minutes.

By one approach, a variety of additional ingredients can be included in the beverage concentrates. The amount, identity, and combination of the additional ingredients are not particularly limited so long as the desired solids content, flavor, and stability of the ingredients are maintained. Further, certain ingredients, such as salts, may be more stable in terms of delaying or preventing precipitation when the concentrate includes lower amounts of water.

### Methods for Making the Coffee-Tea Based Beverage Mixture

In some approaches, the coffee-tea based beverage mixture can be prepared using a cold brewing process by pouring the desired amount of water into the vessel and placing a filter into the vessel. The water is a range of ninety (90%) to ninety-six-point-five (96.5%) percent cold water by weight of the final mixture. In an embodiment, the vessel can be any vessel made of plastic, glass, metal, or any other materials that are used and compatible with food making. In an embodiment, the vessel can be a coffee brewing jar.

A freshly ground non-roasted or roasted coffee and tea are added into the vessel through the filter so that they can be removed after the brewing process. In an embodiment, the coffee is added in a range of three to eight-point-five (3%-8.5%) percent ground coffee by weight of the mixture. The coffee is non-roasted or roasted coffee selected from the variety Arabica (Coffea arabica), Robusta (Coffea canephora), or a combination of the two. In an aspect, the tea is added in a range of point-fifteen to one-point-fifteen (0.15%-1.15%) percent ground tea by weight of the mixture. The tea (Camellia sinensis) is any of from white, black, or green varieties. In an embodiment, the coffee and tea are blended in the range of ratios of six to one (6:1) to twenty-two to one-point-twenty-five (22:1.25).

In an embodiment, the mixture is brewed in a vessel for thirty-six to forty-eight (36-48) hours of time. In one aspect, the mixture is brewed for forty-eight (48) to seventy-two (72) hours of time. In an aspect, it is brewed for 24-48 hours of time. In an aspect, the mixture is brewed for 4 minutes to twenty-four (24) hours of time. In an aspect, the mixture is brewed in a range of two-point-seven to four-point-four (2.7-4.4) Celsius of temperature. Further, in an aspect, the mixture is agitated after every pre-defined amount of time. In an aspect, a sweetener or a creamer is added to the resulting brewed beverage mixture.

The foregoing descriptions are not intended to represent only forms of the concentrates in regard to the details of the formulation. The percentages provided herein are by weight unless stated otherwise. Changes in form and in the proportion of parts, as well as the substitution of equivalents, are contemplated as circumstances may suggest or render expedient. Similarly, while concentrates and methods have been described herein in conjunction with specific embodiments, many alternatives, modifications, and variations will be apparent to those skilled in the art in light of the foregoing description.

1. A coffee-tea based beverage mixture, comprising:
about ninety to ninety-six-point-five (90%-96.5%) percent water by weight of the mixture;
a range of three to eight-point-five (3%-8.5%) percent ground coffee by weight of the mixture; and
about point-fifteen to one-point-five (0.15%-1.5%) percent ground tea by weight of the mixture.

2. The beverage mixture of claim 1, wherein the coffee is non-roasted or roasted coffee.

3. The beverage mixture of claim 1, wherein the coffee is arabica or robusta coffee.

4. The beverage mixture of claim 1, wherein the tea is white, black, or green tea varieties.

5. The beverage mixture of claim 1, wherein the coffee or tea are flavored or unflavored.

6. The beverage mixture of claim 1, wherein the coffee and tea are blended in a range of ratios of six to one (6:1) to twenty-two to one-point-twenty-five (22:1.25).

7. The beverage mixture of claim 1, wherein the tea and the coffee are brewed together using any of a cold, drip, espresso, or French press brewing methods.

8. The beverage mixture of claim 7, wherein the mixture as a cold brew, is brewed at between two-point-seven to four-point-four (2.7° C.-4.4° C.) Celsius for thirty-six to forty-eight (36-48) hours of time.

9. The beverage mixture of claim 8, wherein the mixture is a cold brew and agitated every eighteen to twenty-four (18-24) hours.

10. The beverage mixture of claim 7, wherein the mixture as an espresso brew, is brewed at between ninety-seven to one hundred four (97° C.-104° C.) Celsius at a pressure of one to fifteen (1-15) bars of pressure for thirty to ninety (30-90) seconds of time.

11. The beverage mixture of claim 7, wherein the mixture as a drip brew, is brewed at between ninety-seven to one hundred four (97° C.-104° C.) Celsius for five to 10 (5-10) minutes of time.

12. The beverage mixture of claim 7, wherein the mixture as a French Press brew, is brewed at between ninety-seven to one hundred four (97° C.-104° C.) Celsius for two to six (2-6) minutes of time.

13. The beverage mixture of claim 1, wherein the mixture comprises approximately sixty (60%) percent to ninety (90%) percent water by weight of the mixture.

14. The beverage mixture of claim 1, wherein the water is hot water.

15. The beverage mixture of claim 1, wherein the resulting brewed beverage mixture may include a sweetener.

16. The beverage mixture of claim 1, wherein the resulting brewed beverage mixture may include a creamer.

17. A coffee-tea based beverage mixture, comprising:
about ninety to ninety-six-point-five (90%-96.5%) percent water by weight of the mixture;
about three to eight-point-five (3%-8.5%) percent ground coffee by weight of the mixture;
about one half percent to about one and a half (0.5%-1.5%) percent ground tea by weight of the mixture, the mixture as a cold brew, is brewed at between two-point-seven to four-point-four (2.7° C.-4.4° C.) Celsius for thirty-six to forty-eight (36-48) hours of time and agitated at every eighteen to twenty-four (18-24) hours; and
a sweetener and a creamer added to the resulting brewed beverage.

18. The beverage mixture of claim 1, wherein the water is cold or hot water.

19. The beverage mixture of claim 1, wherein the coffee and tea are blended in a range of ratios of six to one (6:1) to twenty-two to one-point-twenty-five (22:1.25).

20. A method of preparing a coffee-tea based beverage mixture, comprising steps of:
providing approximately three to eight-point-five (3%-8.5%) percent ground coffee by weight of the mixture;
providing approximately point-fifteen to one-point-fifteen (0.15%-1.15%) percent ground tea by weight of the mixture;
mixing the non-roasted ground coffee and the ground tea with approximately ninety to ninety-six-point-five (9%-96.5%) percent cold water by weight of the mixture;
keeping the mixture at between two-point-seven to four-point-four (2.7° C.-4.4° C.) Celsius for thirty-six to forty-eight (36-48) hours of time as a cold brew; and
agitating the mixture at every eighteen to twenty-four (18-24) hours as a cold brew.
